(19) United States
(12) Patent Application Publication
(10) Pub. No.: US 2026/0067627 A1
(43) Pub. Date: Mar. 5, 2026

(54) APPARATUS FOR DIAGNOSING SOUND OUTPUT LAMP AND METHOD THEREOF

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/257,367

(22) Filed: Jul. 1, 2025

(30) Foreign Application Priority Data
Sep. 4, 2024 (KR) 10-2024-0120287

(51) Int. Cl. H04R 29/00; B60Q 1/00; H04R 1/02; H04R 1/46; H04R 17/02

(52) U.S. Cl. CPC H04R 29/001; B60Q 1/0017; H04R 1/028; H04R 1/46; H04R 17/02; H04R 2499/13

(57) ABSTRACT

An apparatus for diagnosing a sound output lamp, and a method therefor are provided. The apparatus includes a sound piezo formed in a stack structure to vibrate a surface of an outer lens or a housing of the lamp to output sound, an audio driving device to generate power for audio driving of the sound piezo, a fault detection piezo in contact with the surface of the outer lens or the housing of the lamp to generate an electric signal in response to the surface of the outer lens or the housing being vibrated by the sound piezo, and a controller to control audio output of the sound piezo to the audio driving device, and diagnose whether the sound piezo is out of order based on whether the electric signal is received from the fault detection piezo in response to the audio signal being provided to the audio driving device.

### CROSS-REFERENCE TO RELATED APPLICATION

This application claims the benefit of priority, under 35 USC § 119 (a), to Korean Patent Application No. 10-2024-0120287, filed in the Korean Intellectual Property Office on Sep. 4, 2024, the entire contents of which are incorporated herein by reference for all purposes.

### BACKGROUND

### 1. Field

The present disclosure relates to a technology for diagnosing a failure of a sound output lamp, and more particularly, to an apparatus for diagnosing a failure of a sound output lamp which is capable of diagnosing a failure of a piezo in a sound output lamp using a piezo, and a method thereof.

### 2. Description of the Related Art

The headlamps of a vehicle are important in terms of both the function and design of the vehicle. The headlamps provide the driver with visibility at night and serve the function of notifying other vehicles and pedestrians of the presence of the vehicle. The headlamps are such an important design element that they may be called the eyes of a vehicle. The headlamps are a major component that is subject to change, even in models with partial change (facelift).

Before the 1970s, incandescent bulbs called filament bulbs were used as headlamps, but the filament bulbs had limited usability as headlamps due to their short lifespan and low brightness. Halogen lamps developed later have a wide light diffusion angle, provide easy field of view, and are able to be miniaturized. Thereafter, high intensity discharge (HID) lamps have been rapidly replaced by LED lamps.

Recently, automobile headlamps are not limited to simply emitting light to secure forward visibility, but are also provided to perform entertainment or communication functions through the output of various image signals.

However, although the current vehicle lamps, including headlamps, output image signals, the vehicle lamps do not output audio signals.

Of course, it is possible to configure a voice output to be performed through a voice output device at a location other than the vehicle lamp, but in order to output a voice through the headlamp, a hole for mounting a separate voice output device is formed in an outer housing of the vehicle lamp, typically an outer lens, and the voice output device must be installed therein. However, this increases the work load and external substances such as rainwater may enter the lamp.

Therefore, there is a demand for improvement in a vehicle lamp capable of performing various functions including entertainment functions and communication functions, by performing a voice output in synchronization with an image output of the vehicle lamp.

### SUMMARY

The present disclosure has been made to solve the above-mentioned problems occurring in the prior art while advantages achieved by the prior art are maintained intact.

One aspect of the present disclosure provides an apparatus for diagnosing a failure of a sound output lamp that is capable of diagnosing whether a piezo is out of order in the sound output lamp using a piezo, and a method thereof.

Another aspect of the present disclosure provides an apparatus for diagnosing a failure of a sound output lamp that is capable of diagnosing whether a piezo is out of order and preventing an accident that may be caused by a lamp failure in advance, and a method thereof.

Still another aspect of the present disclosure provides an apparatus for diagnosing a failure of a sound output lamp that is capable of estimating the remaining life time of a piezo, and a method thereof.

The technical problems to be solved by the present disclosure are not limited to the aforementioned problems, and any other technical problems not mentioned herein will be clearly understood from the following description by those skilled in the art to which the present disclosure pertains.

In a general aspect of the disclosure, an apparatus for diagnosing a sound output lamp, includes: a sound piezo formed in a stack structure and configured to vibrate a surface of an outer lens or a housing of the lamp to output sound; an audio driving device configured to generate power for audio driving of the sound piezo; a fault detection piezo in contact with the surface of the outer lens or the housing of the lamp and configured to generate an electric signal in response to the surface of the outer lens or the housing being vibrated by the sound piezo; and a controller configured to provide an audio signal for controlling audio output of the sound piezo to the audio driving device, and diagnose whether the sound piezo is out of order based on whether the electric signal is received from the fault detection piezo in response to the audio signal being provided to the audio driving device.

The apparatus may further include an ultrasonic receiving device configured to receive an ultrasonic signal, wherein the controller may be further configured to provide an audio signal for an ultrasonic wave to the audio driving device to output an ultrasonic sound from the sound piezo, and diagnose whether the sound piezo is out of order based on whether the ultrasonic receiving device receives the ultrasonic signal corresponding to the ultrasonic sound.

The apparatus of claim 1, wherein the controller may be further configured to calculate an impedance of the sound piezo based on a voltage value and a current value of the sound piezo, and estimate a remaining life time of the sound piezo based on the impedance of the sound piezo.

The controller may be further configured to estimate the remaining life time based on an initial impedance preset for the sound piezo, an impedance at an end-of-life time point, and the calculated impedance.

The apparatus may further include a protection device arranged between the audio driving device and the sound piezo and configured to prevent electricity generated from the sound piezo by vibration of a vehicle from flowing into the audio driving device by discharging the electricity while no electricity is applied to the sound piezo.

The controller may be further configured to high-pass filter the electric signal with a preset frequency or higher when receiving the electric signal from the fault detection piezo, and diagnose that the sound piezo is out of order in response to the electrical signal having the preset frequency or higher being less than a preset threshold value.

In another general aspect of the disclosure, an apparatus for diagnosing a sound output lamp, includes: a piezo formed in a stack structure and configured to vibrate a surface of an outer lens or a housing of the lamp to output sound; an audio driving device configured to generate power for audio driving of the piezo; an ultrasonic receiving device configured to receive an ultrasonic signal; and a controller configured to provide an audio signal for an ultrasonic wave to the audio driving device to output an ultrasonic sound from the piezo, and diagnose whether the piezo is out of order based on whether the ultrasonic receiving device receives the ultrasonic signal corresponding to the ultrasonic sound.

The controller may be further configured to calculate an impedance of the piezo based on a voltage value and a current value of the piezo, and estimate a remaining life time of the piezo based on the impedance of the piezo.

The controller may be further configured to estimate the remaining life time based on an initial impedance preset for the piezo, an impedance at an end-of-life time point, and the calculated impedance.

The apparatus may further include a protection device arranged between the audio driving device and the piezo and configured to prevent electricity generated from the piezo by vibration of a vehicle from flowing into the audio driving device by discharging the electricity while no electricity is applied to the piezo.

In yet another general aspect of the disclosure, a method of diagnosing a sound output lamp, includes: providing a sound signal to a sound piezo that is formed in a stack structure and vibrating a surface of an outer lens or a housing of the lamp; checking whether an electric signal is received from a fault detection piezo that is in close contact with the surface of the outer lens or the housing of the lamp; and diagnosing whether the sound piezo is out of order based on whether the electric signal is received from the fault detection piezo.

The method may further include: providing an audio signal for an ultrasonic wave to the sound piezo to output an ultrasonic sound from the sound piezo; checking whether an ultrasonic signal corresponding to the ultrasonic sound is received; and diagnosing whether the sound piezo is out of order based on whether the ultrasonic signal is received.

The method may further include: calculating an impedance of the sound piezo based on a voltage value and a current value of the sound piezo; and estimating a remaining life time of the sound piezo based on the impedance of the sound piezo.

The estimating of the remaining life time may include estimating the remaining life time based on an initial impedance preset for the sound piezo, an impedance at an end-of-life time point, and the calculated impedance.

The diagnosing of whether the sound piezo is out of order may include: high-pass filtering the electric signal with a preset frequency or higher in response to the electric signal being received from the fault detection piezo; and diagnosing that the sound piezo is out of order in response to the electrical signal having the preset frequency or higher being less than a preset threshold value.

The features briefly summarized above with respect to the present disclosure are merely exemplary aspects of the detailed description of the present disclosure described below and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for diagnosing a failure of a sound output lamp according to an embodiment of the present disclosure;

FIG. 2 is a block diagram illustrating a process of diagnosing a fault by using an audio signal for an ultrasonic wave;

FIG. 3 is a block diagram illustrating an example of a protection device;

FIG. 4 is a circuit diagram illustrating an example of a configuration for calculating the impedance of a piezo;

FIG. 5 is a graph illustrating a process of estimating the life time of a piezo;

FIG. 6 is a flowchart illustrating a method of diagnosing a failure of a sound output lamp according to another embodiment of the present disclosure; and

FIG. 7 is a block diagram illustrating a computing system for executing a method of diagnosing a failure of a sound output lamp according to an embodiment of the present disclosure.

### DETAILED DESCRIPTION

Hereinafter, various embodiments of the inventive concept will be described in detail with reference to the accompanying drawings, so that those skilled in the art can easily carry out the inventive concept. However, the inventive concept is not limited to the embodiments set forth herein and may be modified variously in many different forms.

In describing the embodiments of the present specification, when a specific description of the related art is deemed to obscure the subject matter of the embodiments of the present specification, the detailed description will be omitted. In the drawings, the portions irrelevant to the description will not be shown in order to make the present disclosure clear.

It will be understood that when an element is referred to as being “connected” or “coupled” to another element, it may be directly connected or indirectly connected to another element. In addition, when some part ‘includes’ or “has” some elements, unless explicitly described to the contrary, it means that other elements may be further included but not excluded.

Expressions such as “first,” or “second,” and the like, may express their elements regardless of their priority or importance and may be used to distinguish one element from another element but is not limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In the present disclosure, components described in various embodiments do not necessarily mean essential components, and some may be optional components. Therefore, an embodiment composed of a subset of components described in an embodiment is also included in the scope of the present disclosure. In addition, embodiments including other components in addition to the components described in various embodiments are also included in the scope of the present disclosure.

In the present disclosure, expressions of positional relationships used herein, such as upper, lower, left, right, and the like, are described for convenience of description. When viewing the drawings shown in this specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

An external vehicle speaker may be mainly used as a pedestrian warning sound, so the external vehicle speaker may threaten the safety of pedestrians when the external vehicle speaker is out of order. Because a driver is inside the vehicle and may not be aware of a malfunction of the external vehicle speaker, the vehicle must be able to diagnose itself. In the case of a general speaker, because the main cause of failure is a coil break, failure diagnosis is possible simply by detecting the open load. However, in the case of a piezo, the impedance varies depending on the frequency, and specifically, the impedance is almost infinite (Open) at DC (0 Hz) where the open load is detected, so piezo failure may not be diagnosed by detecting the open load.

The embodiments of the present disclosure aim to prevent accidents that may occur due to lamp failure in advance by diagnosing whether a piezo is out of order by using an ultrasonic signal which is generated from the piezo by using a separate fault diagnosis piezo or using an audio signal for an ultrasonic wave.

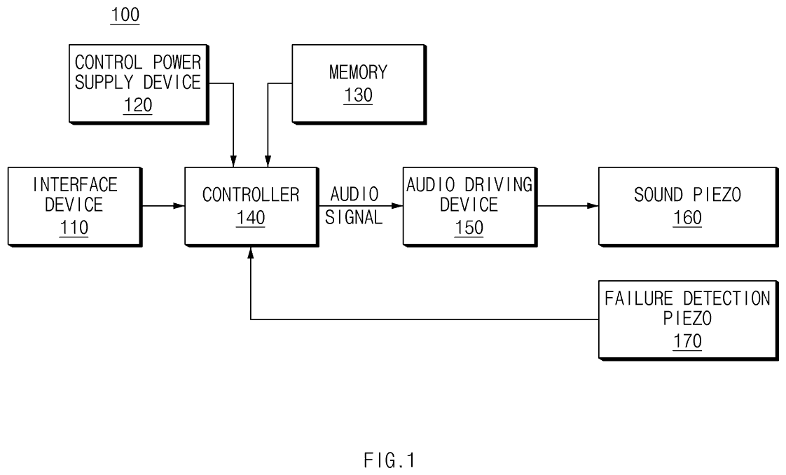

FIG. 1 is a block diagram illustrating a configuration of an apparatus for diagnosing a failure of a sound output lamp according to an embodiment of the present disclosure.

Referring to FIG. 1, an apparatus 100 for diagnosing a failure of a sound output lamp according to an embodiment of the present disclosure includes an interface device 110, a control power supply device 120, a memory 130, a controller 140, an audio driving device 150, a sound piezo 160, and a failure detection piezo 170.

The interface device 110 provides a lamp control signal from a vehicle and information obtained from sensors, navigation and the like, such as surrounding environment information, road information, and the like, to the controller.

In this case, the interface device 110 may be a general configuration device provided in the vehicle and may include all interface devices provided in the vehicle.

The control power supply device 120 supplies power for driving the controller 140 from a vehicle battery.

The memory 130 may store all data related to the technology of the present disclosure, and for example, may store audio data, data on an algorithm for controlling an audio signal, and the like.

The controller 140 controls the light source output of the lamp, controls the audio output, and diagnoses whether the sound piezo 160 is out of order, based on the information obtained from the vehicle.

According to an embodiment, the controller 140 may provide an audio signal for controlling the audio output of the sound piezo 160 to the audio driving device 150.

According to an embodiment, the controller 140 may diagnose whether the sound piezo 160 is out of order based on whether an electric signal is received from the failure detection piezo 170 when providing an audio signal to the audio driving device 150.

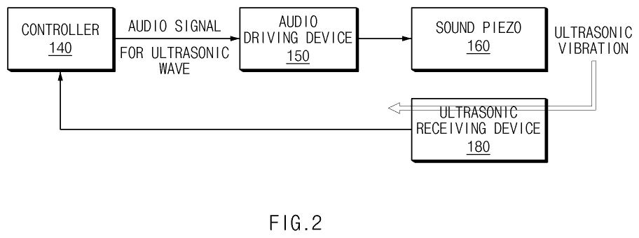

According to an embodiment, the controller 140 may provide an audio signal for an ultrasonic wave to the audio driving device 150 such that an ultrasonic sound is output from the sound piezo 160, and may also diagnose whether the sound piezo 160 is out of order based on whether an ultrasonic signal corresponding to the ultrasonic sound is received at a device for receiving an ultrasonic signal, for example, an ultrasonic receiver equipped in a vehicle. The details will be described in FIG. 2.

According to an embodiment, when an electric signal is received from the failure detection piezo 170, the electric signal may be high-pass filtered with a preset frequency or higher. When an electric signal higher than the preset frequency or higher is received, the controller 140 may diagnose that a fault occurs in the sound piezo 160. This is because the vehicle body may vibrate while the vehicle is driven, and the vibration may be transmitted to the lamp, so the failure diagnosis of the sound piezo 160 may be misrecognized due to the electric signal of the failure detection piezo 170 that may be generated by the vibration of the vehicle body. Therefore, by removing the electric signal generated by the vibration of the vehicle body using a high-pass filter, it may be possible to prevent misrecognition of a failure of the sound piezo 160 that may be caused by the vibration of the vehicle itself. Because the vibration of the vehicle body generally has a frequency of less than 500 Hz, when vibration frequencies of 500 Hz or higher is monitored, it may be possible to prevent misrecognition of faults due to vehicle vibration. That is, when the electric signal output from the fault detection piezo passes through an HPF having a cut-off frequency of 500 Hz or higher and is input to an ADC, and the ADC converts the analog signal into a digital signal and provides it to the controller 140, the controller may determine that the sound piezo 160 operates normally when the value is greater than a specified threshold value, and when the value is less than the specified threshold value, the controller may determine that a fault occurs in the sound piezo 160. Of course, the cut-off frequency of the high-pass filter is not limited or restricted to 500 Hz, and the cut-off frequency of the high-pass filter may be changed depending on the situation.

The audio driving device 150 generates power for audio driving based on an audio signal input from the controller 140 and provides the generated power to the sound piezo 160.

According to an embodiment, the audio driving device 150 may provide power to the sound piezo 160 to enable the sound piezo 160 to generate an ultrasonic signal based on an audio signal for an ultrasonic wave input from the controller 140.

Meanwhile, the audio driving device 150 receives an audio signal from the controller 140 equipped in the vehicle, converts the audio signal into a PWM signal, and amplifies the PWM signal. It is preferable to use a class D amplifier having the characteristics of high performance, high efficiency, and ultra-light weight as the audio driving device 150.

The class D amplifier, which is a digital amplifier that amplifies an audio signal in a digital state, converts an audio signal into a pulse width modulation (PWM) signal and then amplifies the PWM signal.

The sound piezo 160 refers to a piezo speaker and outputs a desired sound based on the power input from the audio driving device 150.

In this case, the sound piezo 160 may come into contact with the outer lens or housing of the lamp and vibrate the surface of the outer lens or housing to output a sound.

The sound piezo 160, which is a device that uses the piezoelectric effect in reverse, which generates electricity when pressure is applied, operates on the principle that when electricity is applied and contraction and expansion are repeated, sound is output according to the vibration.

The sound piezo 160 is attached to the inner surface of the outer lens and provides a vibration corresponding to an audio signal to the outer lens, thereby causing the outer lens to vibrate and the vibration outputs a sound in the forward direction of the vehicle lamp, that is, the sound output lamp.

Meanwhile, when one side of the sound piezo 160 is in close contact with the inner surface of the outer lens, it is preferable that the contact surface of the outer lens is configured to geometrically correspond to one side contact surface of the sound piezo 160 such that vibration transmission is smooth.

That is, the contact surface of the sound piezo 160 and the contact surface of the outer lens may be formed to correspond geometrically to each other, so that the contact ratio increases, and thus the vibration of the sound piezo may be smoothly transmitted to the outer lens.

When the failure detection piezo 170 comes into contact with the outer lens or housing of the lamp and the surface of the outer lens or housing vibrates without receiving an electric signal from an outside, the failure detection piezo 170 generates an electric signal by the piezoelectric effect and provides the electric signal generated in such a manner to the controller 140.

When the failure detection piezo 170 comes into close contact with the inner surface of the outer lens like the sound piezo 160 and the surface of the outer lens or housing vibrates due to the sound piezo 160, the failure detection piezo 170 generates an electric signal and provides the generated electric signal to the controller 140.

Although not shown in FIG. 1, a sound output lamp to which the technology of the present disclosure is applied may include a light source that irradiates light and an outer lens arranged in front of the light source.

In this case, the light source may be mainly applied to a daytime running light (DRL), which is commonly referred to as a general automobile headlamp, but may also be applied to various vehicle lamps such as turn signals, fog lamps, side markers, rear lamps, brake lights, and the like.

In this case, the outer lens may be positioned forward in the light irradiation direction of the light source, and serve as a housing for a vehicle lamp that protects the light source from being exposed to the outside, while also allowing the light irradiated from the light source to be smoothly dispersed.

FIG. 2 is a block diagram illustrating a process of diagnosing a fault by using an audio signal for an ultrasonic wave.

An apparatus according to an embodiment of the present disclosure may also diagnose whether the sound piezo 160 is out of order by using an ultrasonic signal. To this end, an apparatus according to an embodiment of the present disclosure may further include an ultrasonic receiving device 180, as illustrated in FIG. 2.

In this case, the ultrasonic receiving device 180 may use an ultrasonic sensor equipped in a vehicle.

That is, it is possible to determine whether the sound piezo 160 is out of order by using the ultrasonic receiving device 180 of the ultrasonic sensor at a time point when the ultrasonic sensor equipped in the vehicle is not used. In detail, the controller 140 provides an audio signal for an ultrasonic wave to the audio driving device 150 to enable the sound piezo 160 to generate an ultrasonic signal, thereby allowing the ultrasonic signal to be generated through ultrasonic vibration of the sound piezo 160. The ultrasonic signal generated by the sound piezo 160, that is, the ultrasonic sound, may be reflected by an object and the like, and received by the ultrasonic receiving device 180. The controller 140 may diagnose whether the sound piezo 160 is out of order by determining whether the ultrasonic signal received by the ultrasonic receiving device 180 corresponds to the corresponding frequency of the audio signal for an ultrasonic wave. In this case, the controller 140 may receive the ultrasonic signal received by the ultrasonic receiving device 180 after performing a preset signal processing process.

In the case of an ultrasonic sensor, a specific frequency band may be filtered and used, so the controller 140 may provide an audio signal for an ultrasonic wave corresponding to the filtering frequency, and accordingly, the ultrasonic sound corresponding to the filtering frequency may be output from the sound piezo 160. The ultrasonic sensor equipped in the vehicle may be used to detect obstacles at a short distance, and may not operate while driving. Therefore, by outputting an ultrasonic sound at that time and determining whether the ultrasonic sound is received by the ultrasonic sensor, it is possible to diagnose whether the sound piezo 160 is out of order. Of course, when diagnosing whether the sound piezo 160 is out of order by using the ultrasonic receiving device 180, the failure detection piezo 170 may not be provided, or the failure detection piezo 170 may be provided. That is, it is possible to diagnose whether the sound piezo 160 is out of order by using both the failure detection piezo 170 and the ultrasonic sound, or it is possible to diagnose whether the sound piezo 160 is out of order by using either the failure detection piezo 170 or the ultrasonic sound.

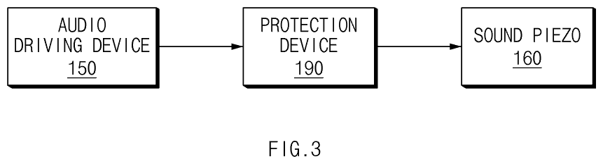

FIG. 3 is a block diagram illustrating an example of a protection device.

The sound piezo 160 generates electricity by the piezoelectric direct effect when pressure is applied thereto, and vibrates by the piezoelectric converse effect when electricity is applied thereto. When electricity is generated in the sound piezo 160 due to vehicle vibration while no sound is output and no electricity is applied to the sound piezo 160, the electricity generated by the sound piezo 160 may flow inversely into the circuit of the audio driving device 150, causing damage to the circuit. Accordingly, as illustrated in FIG. 3, an apparatus according to the embodiment of the present disclosure may further include a protection device 190 that is arranged between the audio driving device 150 and the sound piezo 160 and discharges electricity generated from the sound piezo 160 by vibration of the vehicle to prevent the electricity from flowing into a circuit such as the audio driving device 150 in a state where no electricity is applied to the sound piezo 160.

In this case, the protection device 190 may include a circuit that discharges the charged electricity even though the sound piezo 160 is charged with electricity. For example, the protection device 190 may include a circuit in which a capacitor and a resistor are connected in series to GND, and when the charges charged in the sound piezo 160 flows into the circuit, the charges flows through the protection device 190 to GND, thereby protecting the circuit.

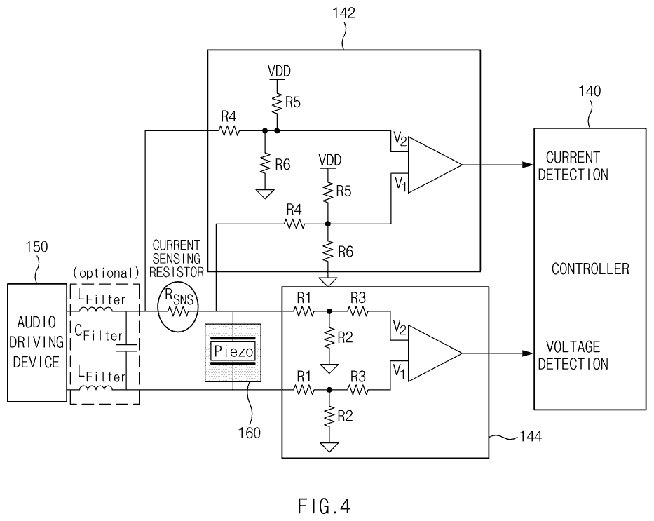

FIG. 4 is a circuit diagram illustrating an example of a configuration for calculating the impedance of a piezo.

As shown in FIG. 4, a current sensing resistor is formed between the audio driving device 150 and the sound piezo 160, and the current value flowing into the sound piezo 160 is calculated through a device 142 for calculating the current value flowing into the sound piezo 160 and is provided to the controller 140. In this case, the device 142 for calculating the current value flowing into the sound piezo 160 may calculate the current value flowing into the sound piezo 160 by using the voltage and resistance value between both terminals of the current sensing resistor.

In addition, the device 144 for calculating the voltage value applied to the sound piezo 160 calculates the voltage value applied to the sound piezo 160 as the voltage difference between both terminals of the sound piezo 160 and provides the calculated voltage value to the controller 140.

The controller 140 may receive the current value from the device 142 for calculating the current value flowing into the sound piezo 160 and the voltage value from the device 144 for calculating the voltage value, and may calculate the impedance of the sound piezo 160 based on the current value and voltage value.

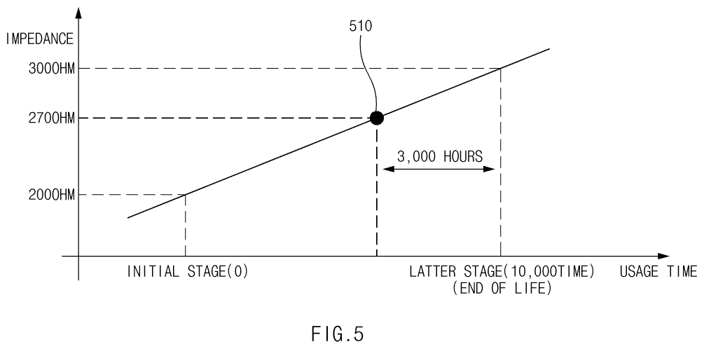

When the impedance of the sound piezo 160 is calculated by the above-described process, as shown in FIG. 5, the remaining life time of the sound piezo 160 may be estimated based on the impedance of the sound piezo 160.

Because a piezo has characteristics similar to those of a capacitor, the longer the piezo is used, the higher the impedance becomes. As described above, because the voltage value and the current value at a specific frequency may be known, it is possible to calculate the impedance of the piezo, that is, the sound piezo 160.

In addition, as shown in FIG. 5, when the impedance value at the initial time point and the impedance value at the end of life are determined or set for the sound piezo 160, the remaining life time of the sound piezo 160 may be estimated using the initial impedance, the impedance at the end of life, and the currently calculated impedance. It is assumed in FIG. 5 that the total life time of the sound piezo 160 is 10,000 hours, the initial impedance is 200 ohms, and the impedance at the end of life is 300 ohms. When the impedance calculated in FIG. 4 is 270 ohms 510, the remaining life time of the sound piezo 160 may be estimated to be 3,000 hours.

When the remaining life time of the sound piezo 160 is estimated through the above-described process, the driver may prepare in advance for a failure of the sound piezo 160 by informing the driver of the expected life time of the sound piezo 160.

As described above, an apparatus for diagnosing a failure of a sound output lamp according to an embodiment of the present disclosure may diagnose whether a piezo is out of order in a sound output lamp using the piezo.

In addition, an apparatus for diagnosing a failure of a sound output lamp according to an embodiment of the present disclosure may diagnose whether a piezo is out of order and prevent an accident that may be caused by a lamp failure in advance.

In addition, an apparatus for diagnosing a failure of a sound output lamp according to an embodiment of the present disclosure may prepare for a failure of a piezo in advance by estimating the remaining life time of the piezo.

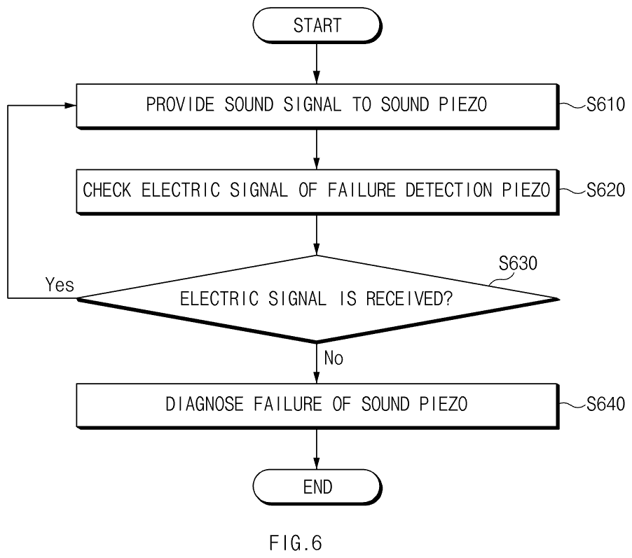

FIG. 6 is a flowchart illustrating a method of diagnosing a failure of a sound output lamp according to another embodiment of the present disclosure. FIG. 6 illustrates a method of operating the apparatus of FIGS. 1 to 5.

Referring to FIG. 6, in S610 and S620, a method of diagnosing a failure of a sound output lamp according to another embodiment of the present disclosure provides a sound signal to a sound piezo, and checks whether an electric signal is received from the failure detection piezo during the time when the sound signal is provided.

In S630 and S640, when an electric signal is received from the failure detection piezo during the time when the sound signal is provided, it is determined that the sound piezo operates normally, and when the electric signal is not received from the failure detection piezo during the time when the sound signal is provided, the sound piezo is diagnosed to be faulty.

According to an embodiment, in S640, when the electric signal is received from the failure detection piezo, the electric signal may be high-pass filtered with a preset frequency or higher, and when the electric signal having the preset frequency or higher is less than the preset threshold value, the sound piezo may be diagnosed to be faulty.

In addition, as shown in FIG. 2, a method of diagnosing a failure of a sound output lamp according to another embodiment of the present disclosure may perform diagnosis by using an ultrasonic sound. In detail, a method of diagnosing a failure of a sound output lamp according to another embodiment of the present disclosure may provide an audio signal for an ultrasonic wave to a sound piezo such that an ultrasonic sound is output from the sound piezo, and after checking whether an ultrasonic signal corresponding to the ultrasonic sound is received, may diagnose whether the sound piezo is out of order based on whether the ultrasonic signal is received.

In addition, a method of diagnosing a failure of a sound output lamp according to another embodiment of the present disclosure may calculate the impedance of the sound piezo based on the voltage value and the current value of the sound piezo, and may estimate the remaining life time of the sound piezo based on the impedance of the sound piezo.

Even though the description is omitted in a method according to another embodiment of the present disclosure, the method according to another embodiment of the present disclosure may include all the contents described in the apparatus of FIGS. 1 to 5, which is obvious to a person skilled in the art.

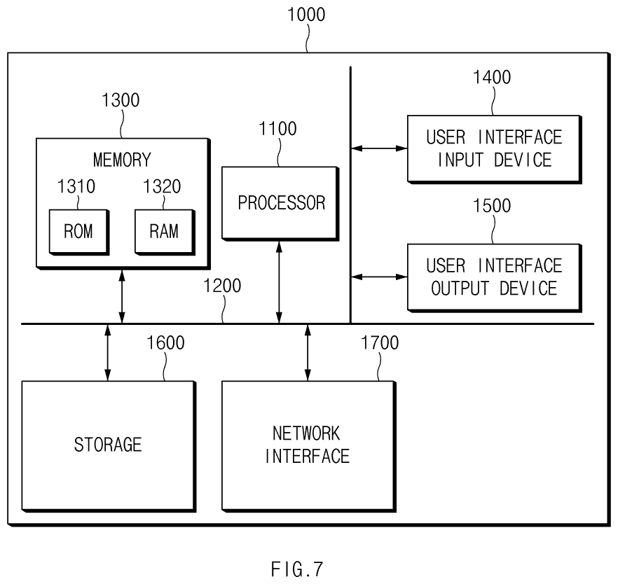

FIG. 7 is a block diagram illustrating a computing system for executing a method of diagnosing a failure of a sound output lamp according to an embodiment of the present disclosure.

Referring to FIG. 7, as described above, the method of diagnosing a failure of a sound output lamp according to an embodiment of the present disclosure may be implemented through a computing system. The computing system 1000 may include at least one processor 1100, a memory 1300, a user interface input device 1400, a user interface output device 1500, storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the present disclosure, it is possible to diagnose whether a piezo is out of order in a sound output lamp using a piezo.

According to the present disclosure, it is possible to diagnose whether a piezo is out of order, thereby preventing an accident that may be caused by a lamp failure in advance.

According to the present disclosure, it is possible to prepare for piezo failure in advance by estimating the remaining life time of the piezo.

Effects obtained by various embodiments of the disclosure may not be limited to the above, and other effects will be clearly understandable to those having ordinary skill in the art from the following disclosures.

Although exemplary embodiments of the present disclosure have been described for illustrative purposes, those skilled in the art will appreciate that various modifications, additions and substitutions are possible, without departing from the scope and spirit of the disclosure. Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for diagnosing a sound output lamp, the apparatus comprising:
a sound piezo formed in a stack structure and configured to vibrate a surface of an outer lens or a housing of the lamp to output sound;
an audio driving device configured to generate power for audio driving of the sound piezo;
a fault detection piezo in contact with the surface of the outer lens or the housing of the lamp and configured to generate an electric signal in response to the surface of the outer lens or the housing being vibrated by the sound piezo; and
a controller configured to:
provide an audio signal for controlling audio output of the sound piezo to the audio driving device; and
diagnose whether the sound piezo is out of order based on whether the electric signal is received from the fault detection piezo in response to the audio signal being provided to the audio driving device.

2. The apparatus of claim 1, further comprising:
an ultrasonic receiving device configured to receive an ultrasonic signal,
wherein the controller is further configured to:
provide an audio signal for an ultrasonic wave to the audio driving device to output an ultrasonic sound from the sound piezo; and
diagnose whether the sound piezo is out of order based on whether the ultrasonic receiving device receives the ultrasonic signal corresponding to the ultrasonic sound.

3. The apparatus of claim 1, wherein the controller is further configured to:
calculate an impedance of the sound piezo based on a voltage value and a current value of the sound piezo; and
estimate a remaining life time of the sound piezo based on the impedance of the sound piezo.

4. The apparatus of claim 3, wherein the controller is further configured to estimate the remaining life time based on an initial impedance preset for the sound piezo, an impedance at an end-of-life time point, and the calculated impedance.

5. The apparatus of claim 1, further comprising:
a protection device arranged between the audio driving device and the sound piezo and configured to prevent electricity generated from the sound piezo by vibration of a vehicle from flowing into the audio driving device by discharging the electricity while no electricity is applied to the sound piezo.

6. The apparatus of claim 1, wherein the controller is further configured to:
high-pass filter the electric signal with a preset frequency or higher when receiving the electric signal from the fault detection piezo; and
diagnose that the sound piezo is out of order in response to the electrical signal having the preset frequency or higher being less than a preset threshold value.

7. An apparatus for diagnosing a sound output lamp, the apparatus comprising:
a piezo formed in a stack structure and configured to vibrate a surface of an outer lens or a housing of the lamp to output sound;
an audio driving device configured to generate power for audio driving of the piezo;
an ultrasonic receiving device configured to receive an ultrasonic signal; and
a controller configured to:
provide an audio signal for an ultrasonic wave to the audio driving device to output an ultrasonic sound from the piezo; and
diagnose whether the piezo is out of order based on whether the ultrasonic receiving device receives the ultrasonic signal corresponding to the ultrasonic sound.

8. The apparatus of claim 7, wherein the controller is further configured to:
calculate an impedance of the piezo based on a voltage value and a current value of the piezo; and
estimate a remaining life time of the piezo based on the impedance of the piezo.

9. The apparatus of claim 8, wherein the controller is further configured to estimate the remaining life time based on an initial impedance preset for the piezo, an impedance at an end-of-life time point, and the calculated impedance.

10. The apparatus of claim 7, further comprising:
a protection device arranged between the audio driving device and the piezo and configured to prevent electricity generated from the piezo by vibration of a vehicle from flowing into the audio driving device by discharging the electricity while no electricity is applied to the piezo.

11. A method of diagnosing a sound output lamp, the method comprising:
providing a sound signal to a sound piezo that is formed in a stack structure and vibrating a surface of an outer lens or a housing of the lamp;
checking whether an electric signal is received from a fault detection piezo that is in close contact with the surface of the outer lens or the housing of the lamp; and
diagnosing whether the sound piezo is out of order based on whether the electric signal is received from the fault detection piezo.

12. The method of claim 11, further comprising:
providing an audio signal for an ultrasonic wave to the sound piezo to output an ultrasonic sound from the sound piezo;
checking whether an ultrasonic signal corresponding to the ultrasonic sound is received; and
diagnosing whether the sound piezo is out of order based on whether the ultrasonic signal is received.

13. The method of claim 11, further comprising:
calculating an impedance of the sound piezo based on a voltage value and a current value of the sound piezo; and
estimating a remaining life time of the sound piezo based on the impedance of the sound piezo.

14. The method of claim 13, wherein the estimating of the remaining life time includes estimating the remaining life time based on an initial impedance preset for the sound piezo, an impedance at an end-of-life time point, and the calculated impedance.

15. The method of claim 11, wherein the diagnosing of whether the sound piezo is out of order includes:
high-pass filtering the electric signal with a preset frequency or higher in response to the electric signal being received from the fault detection piezo; and
diagnosing that the sound piezo is out of order in response to the electrical signal having the preset frequency or higher being less than a preset threshold value.
